(19) United States
(12) Patent Application Publication
(10) Pub. No.: US 2014/0130915 A1
(43) Pub. Date: May 15, 2014

(54) LOW HYSTERESIS FLUID METERING VALVE

(71) Applicants: Chris Bonn, Hartford, CT (US); Todd Haugsjaahabink, Springfield, MA (US)

(72) Inventors: Chris Bonn, Hartford, CT (US); Todd Haugsjaahabink, Springfield, MA (US)

(21) Appl. No.: 13/674,373

(22) Filed: Nov. 12, 2012

(51) Int. Cl. F16K 3/32

(52) U.S. Cl. CPC F16K 3/32
USPC 137/625.3

(57) ABSTRACT

A low hysteresis fluid metering valve includes a valve body having an interior portion, an inlet port, an outlet port including a fluid delivery passage, and a shut-off port. A flow control member is arranged in the interior portion. The flow control member includes a first portion and a second portion. The first portion includes a first end extending to a second end through an intermediate portion having a first metered passage, a second metered passage, and a seal element. The first metered passage is configured and disposed to selectively register with the inlet port and the outlet port when the flow control member is arranged in a first position, and the second metered passage is configured and disposed to register with the shut-off port when the flow control member is arranged in a second position.

### BACKGROUND OF THE INVENTION

Exemplary embodiments pertain to the art of fluid control valves and, more particularly, to a low hysteresis fluid metering valve.

Fluid control systems are employed in a wide array of applications. In an automobile, fuel is guided through jets provided in a carburetor. The jets deliver metered amounts of fuel indirectly into a combustion chamber. Automobiles also employ fuel injectors that deliver metered amounts of fuel directly into a combustion chamber. In jet aircraft, a metering valve provides precise control of fuel flow sent to an engine combustor. Generally, metering valve position is established by a regulated flow from an electro-mechanical interface device (EMID). The metering valve includes a seal that limits fuel leakage into the regulated flow. The seal is subjected to pressure drops that vary with fuel flow and may regularly exceed 1000 psid. The pressure drop increases valve friction causing a hysteresis that leads to a non-linear effect on the EMID. The non-linear effect on the EMID leads to an overshoot in engine speed and knock-on effects, or continued running of the engine when fuel flow is cut off.

### BRIEF DESCRIPTION OF THE INVENTION

Disclosed is a low hysteresis fluid metering valve including a valve body having an interior portion, an inlet port, an outlet port including a fluid delivery passage, and a shut-off port. A flow control member is arranged in the interior portion. The flow control member includes a first portion having a first diameter and a second portion having a second diameter that is smaller than the first diameter. The first portion includes a first end extending to a second end through an intermediate portion. The intermediate portion has a first metered passage, a second metered passage, and a seal element. The first metered passage is configured and disposed to selectively register with each of the inlet port and the outlet port when the flow control member is arranged in a first position, and the second metered passage is configured and disposed to register with the shut-off port when the flow control member is arranged in a second position.

Also disclosed is a low hysteresis fluid metering valve including a valve body having an interior portion, an inlet port, an outlet port including a fluid delivery passage, and a shut-off port. A flow control member including a fluid metering section is arranged in the interior portion. The fluid metering section includes a first end having a first diameter extending to a second end having a second diameter that is substantially equal to the first diameter through an intermediate portion. The intermediate portion has a third diameter that is smaller than the first and second diameters. The intermediate portion includes a first metered passage, a second metered passage, and a seal element. The first metered passage is configured and disposed to selectively register with the inlet port and the outlet port when the flow control member is arranged in a first position, and the second metered passage is configured and disposed to register with the shut-off port when the flow control member is arranged in a second position.

### BRIEF DESCRIPTION OF THE DRAWINGS

The following descriptions should not be considered limiting in any way. With reference to the accompanying drawings, like elements are numbered alike:

FIG. 1 is a schematic view of a low hysteresis fluid metering valve in accordance with an exemplary embodiment shown in a high flow position;

FIG. 2 is a schematic view of the low hysteresis fluid metering valve of FIG. 1 shown in a low flow position; and

FIG. 3 is a schematic view of the low hysteresis fluid metering valve of FIG. 1 shown in a shut-off position.

### DETAILED DESCRIPTION OF THE INVENTION

A detailed description of one or more embodiments of the disclosed apparatus and method are presented herein by way of exemplification and not limitation with reference to the Figures.

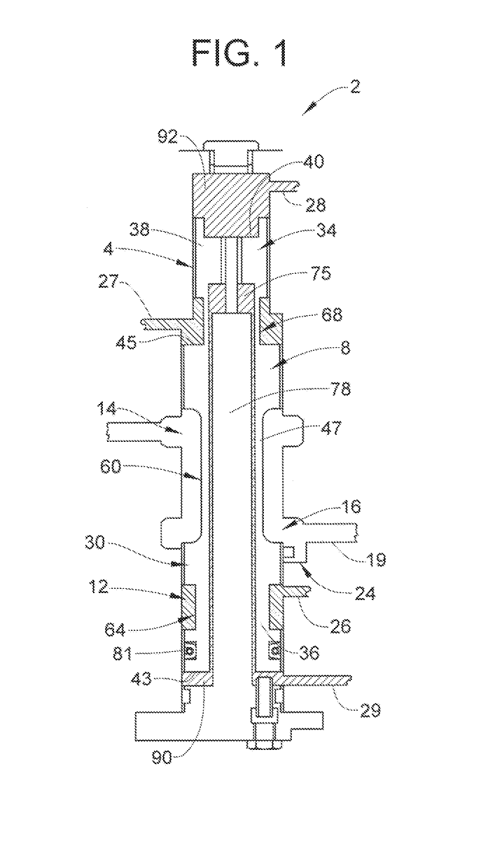

A low hysteresis fluid metering valve in accordance with an exemplary embodiment is indicated generally at 2 in FIG. 1. Low hysteresis fluid metering valve 2 includes a valve sleeve or body 4 and a spool or flow control member 8. Valve body 4 includes an interior portion 12, an inlet port 14, and an outlet port 16 that leads to a fluid delivery passage 19. Fluid delivery passage 19 carries a fluid away from low hysteresis fluid metering valve 2. In the exemplary embodiment shown, fluid delivery passage 19 delivers a metered flow of fuel to a combustor (not shown) of a gas turbine engine (also not shown). Valve body 4 is also shown to include a shut-off port 24, a first low pressure port 26, a second low pressure port 27, a regulated pressure flow port 28 and a modulated pressure flow port 29. As will be detailed more fully below, a modulated pressure fluid (a fluid having a varying pressure) is passed through modulated pressure flow port 29 and acts upon flow control member 8. The modulated pressure fluid selectively shifts flow control member 8 within valve body 4. Fluid maintained at a relatively constant pressure rise relative to second low pressure port 27 introduced through regulated pressure flow port 28, cooperates with the modulated pressure fluid to achieve a desired position of flow control member 8 within valve body 4. The particular position of flow control member 8 establishes fluidic connections between inlet port 14 and outlet port 16, as well as shut-off port 24 and first low pressure port 26.

In further accordance with the exemplary embodiment, flow control member 8 includes a first portion 30 linked to a second portion 34. First portion 30 takes the form of a fluid metering section 36 and second portion 34 takes the form of a regulated pressure section 38 having an end portion 40. Fluid metering section 36 includes a first end 43 having a first diameter that extends to a second end 45 having a second diameter through an intermediate portion 47 having a third diameter. As shown, first and second diameters are substantially equal while the third diameter is smaller than the first and second diameters. In contrast, regulated pressure section 38 includes a diameter that is smaller than the first and second diameter of fluid metering section 36. The particular size of regulated pressure section 38 establishes a desired pressure ratio between modulated pressure fluid introduced through modulated pressure flow port 29 at first end 43 of fluid metering section 36 regulated pressure fluid acting upon end portion 40, and a low pressure fluid acting on end portion 45 to establish a desired position of flow control member 8 within valve body 4.

In still further accordance with the exemplary embodiment, fluid metering section 36 includes a first metered cavity or passage 60, and a second metered cavity or passage 64 and a third cavity or passage 68. First metered passage 60 is arranged generally centrally along intermediate portion 47. Second metered passage 64 is arranged between first metered passage 60 and first end 43. Fluid metering section 36 also includes a central passage 75 that receives a position sensor 78 that provides a feedback signal to a controller (not shown) that controls the modulated pressure fluid introduced through modulated pressure flow port 29 establishing the desired position of flow control member 8. In accordance with an aspect of the exemplary embodiment, position sensor 78 takes the form of a linear variable differential transformer sensor. However, it should be understood that other forms of position sensors may also be employed. A seal 81 is provided on fluid metering section 36 between first end 43 and second fluid metering passage 64. Seal 81 limits leakage of modulated fluid introduced through modulated pressure flow port 29 into the low pressure fluid present within passage 64.

As discussed above, a modulated pressure fluid is introduced through modulated pressure fluid passage 29 and into a modulated pressure flow cavity 90. The modulated fluid acts upon second end 43 and central passage 75 urging end portion 40 of regulated pressure section 38 against regulated pressure fluid, having a generally constant pressure rise relative to the second low pressure port 27, provided in a regulated pressure cavity 92 fluidically connected with pressure regulating fluid passage 28. FIG. 1 illustrates flow control member 8 in a first or high flow position. In the high flow position, outlet port 16 is fully open allowing flow from inlet port 14 through the first metered passage 60.

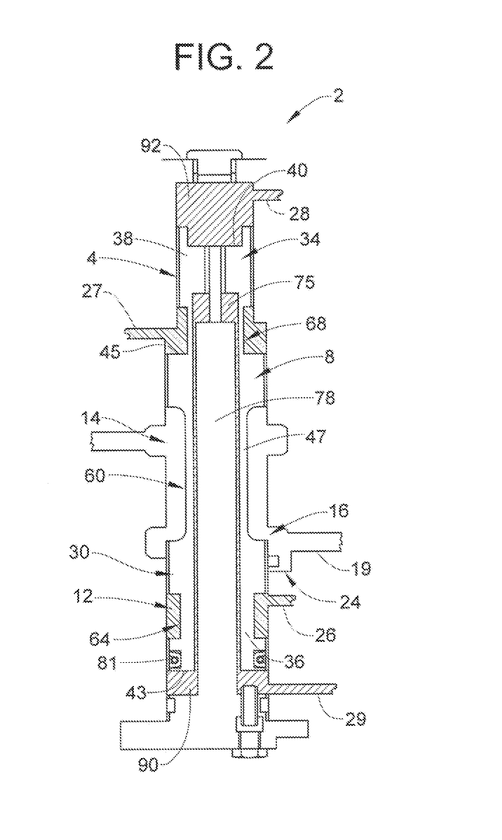

The modulated pressure fluid entering modulated pressure fluid passage 29 may be adjusted to move flow control member 8 to a second or low flow position as shown in FIG. 2. In the low flow position, outlet port 16 is only slightly open allowing less flow from inlet port 14 through the first metered passage 60. Of course, it should be understood that flow control member 8 may be positioned in any one of an infinite number of intermediate positions to control fluid between inlet port 14 and outlet port 16. Both second metered flow passage 64 and third cavity 68 constitute low pressure or drain flow passages. Cavity 68 provides the fluid at a pressure that balances flow control member 8 against fluid within regulated pressure cavity 92 and modulated pressure cavity 90.

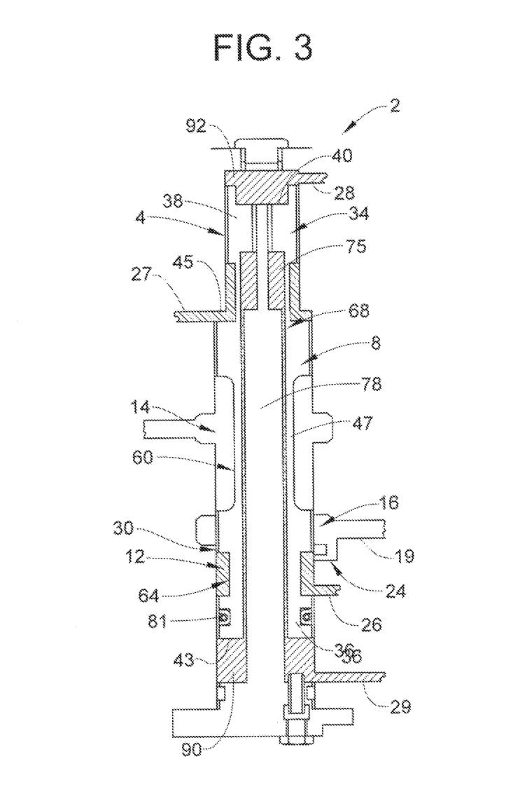

Flow control member 8 is also selectively positionable into a third or shut-off position as shown in FIG. 3. In the third position, metered flow passage 64 is configured to selectively register first low pressure port 26 with shut-off port 24. That is, the modulated fluid is controlled to shift flow control member 8 to the shut-off position. In the shut-off position, outlet port 16 is fully closed allowing no flow from inlet port 14 through first metered passage 60. In this position, fluid may pass from fluid delivery passage 19 back into low hysteresis fluid metering valve 2 at a low pressure. The fluid passes through second fluid metering passage 64 and is directed from valve body 4 through first low pressure port 26. In this configuration, fluid flow downstream from low hysteresis fluid metering valve 2 is shut-off and pressure in fluid delivery passage 19 is reduced to low pressure.

At this point it should be understood that the exemplary embodiments describe a fluid metering valve that reduces hysteresis effects and overshoot for a controlled engine. Specifically, combining metered flow, shut-off flow, and low pressure flow on a single, relatively constant diameter section, a pressure drop across the seal is maintained at a relatively constant and low level. Maintaining the pressure drop at constant and lower levels reduces friction at the seal while still limiting fluid exchange to or from modulated pressure fluid. The reduction in friction allows the flow control member to be more easily positioned within the internal cavity resulting in a relatively low hysteresis for the valve. The reduction in friction also leads to reducing engine speed overshoot and knock on effects that may exist with other valves.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof Therefore, it is intended that the invention not be limited to the particular embodiment disclosed as the best mode contemplated for carrying out this invention, but that the invention will include all embodiments falling within the scope of the claims.

What is claimed is:

1. A low hysteresis fluid metering valve comprising:
a valve body including an interior portion, an inlet port, an outlet port including a fluid delivery passage, and a shut-off port;
a flow control member arranged in the interior portion, the flow control member including a first portion having a first diameter and a second portion having a second diameter that is smaller than the first diameter, the first portion including a first end extending to a second end through an intermediate portion having a first metered passage, a second metered passage, and a seal element, the first metered passage being configured and disposed to selectively register with the inlet port and the outlet port when the flow control member is arranged in a first position, and the second metered passage is configured and disposed to register with the shut-off port when the flow control member is arranged in a second position.

2. The low hysteresis fluid metering valve according to claim 1, wherein the seal is arranged between the first end and the second metered passage.

3. The low hysteresis fluid metering valve according to claim 2, wherein the first metered passage is arranged between the second metered passage and the second end.

4. The low hysteresis fluid metering valve according to claim 1, wherein the shut-off port is fluidly connected to the fluid delivery passage.

5. The low hysteresis fluid metering valve according to claim 1, wherein the second metered passage comprises a low-pressure passage configured and disposed to selectively register with the shut-off port.

6. The low hysteresis fluid metering valve according to claim 5, further comprising: a first low pressure port provided on the valve body, the first low pressure port being configured and disposed to register with the second metered passage when the flow control member is in the first position.

7. The low hysteresis fluid metering valve according to claim 6, further comprising: a second low pressure port provided on the valve body and a low pressure cavity arranged between the first portion and the second portion.

8. The low hysteresis fluid metering valve according to claim 7, wherein the first low pressure port is fluidly connected to the second low pressure port.

9. The low hysteresis fluid metering valve according to claim 7, wherein the shut-off port is fluidly connected to the second low pressure port when the fluid control member is in the second position.

10. The low hysteresis fluid metering valve according to claim 1, further comprising: a regulated pressure flow port and a regulated pressure cavity provided in the valve body, the regulated pressure cavity being arranged at the second portion of the fluid control member, the regulated pressure flow port being configured and disposed to introduce a regulated flow of fluid into the regulated pressure cavity.

11. A low hysteresis fluid metering valve comprising:
a valve body including an interior portion, an inlet port, an outlet port including a fluid delivery passage, and a shut-off port;
a flow control member having a fluid metering section including a first end having a first diameter extending to a second end having a second diameter that is substantially equal to the first diameter through an intermediate portion having a third diameter that is smaller than the first and second diameters, the intermediate portion including a first metered passage, a second metered passage, and a seal element, the first metered passage being configured and disposed to selectively register with the inlet port and the outlet port when the flow control member is arranged in a first position, and the second metered passage is configured and disposed to register with the shut-off port when the flow control member is arranged in a second position.

12. The low hysteresis fluid metering valve according to claim 11, wherein the seal is arranged between the first end and the second metered passage.

13. The low hysteresis fluid metering valve according to claim 12, wherein the first metered passage is arranged between the second metered passage and the second end.

14. The low hysteresis fluid metering valve according to claim 11, wherein the shut-off port is fluidly connected to the fluid delivery passage.

15. The low hysteresis fluid metering valve according to claim 11, wherein the second metered passage comprises a low-pressure passage configured and disposed to selectively register with the shut-off port.

16. The low hysteresis fluid metering valve according to claim 15, further comprising: a first low pressure port provided on the valve body, the first low pressure port being configured and disposed to register with the second metered passage when the flow control member is in the first position.

17. The low hysteresis fluid metering valve according to claim 16, further comprising: a second low pressure port provided on the valve body and a low pressure cavity arranged at the second end of the fluid control member.

18. The low hysteresis fluid metering valve according to claim 17, wherein the first low pressure port is fluidly connected to the second low pressure port.

19. The low hysteresis fluid metering valve according to claim 17, wherein the shut-off port is fluidly connected to the second low pressure port when the fluid control member is in the second position.

20. The low hysteresis fluid metering valve according to claim 11, further comprising: a regulated pressure flow port and a regulated pressure cavity provided in the valve body, the regulated pressure flow cavity being arranged at a regulated pressure flow section extending from the second end of the flow control member.
